(19) United States
(12) Patent Application Publication
(10) Pub. No.: US 2009/0088112 A1
(43) Pub. Date: Apr. 2, 2009

(54) RECEIVING APPARATUS FOR WIRELESS COMMUNICATION, AND RECEIVING METHOD FOR RECEIVING APPARATUS

(75) Inventor: Katsuya NONIN, Kanagawa (JP)

Correspondence Address: FOLEY AND LARDNER LLP;SUITE 500, 3000 K STREET NW, WASHINGTON, DC, 20007, US

(73) Assignee: KABUSHIKI KAISHA TOSHIBA

(21) Appl. No.: 12/237,012

(22) Filed: Sep. 24, 2008

(30) Foreign Application Priority Data
Sep. 28, 2007 (JP) 2007-255688

(51) Int. Cl. H04B 1/06

(52) U.S. Cl. 455/234.1

(57) ABSTRACT

A receiving apparatus for wireless communication is provided with an offset value calculating unit configured to time-average the received signal from the orthogonal demodulator to the demodulator to detect a DC offset value, and feed back the DC offset value to a signal channel from the orthogonal demodulator to the demodulator, an automatic gain controlling unit configured to calculate and time-average a power of the received signal from the orthogonal demodulator to the demodulator to generate an AGC signal, and control a gain of an amplifier, and a controlling unit configured to control to interlock (synchronize) a DC offset value detecting operation of the offset value calculating unit and an AGC signal generating operation of the automatic gain controlling unit.

### CROSS-REFERENCE TO RELATED APPLICATION

This application is based upon and claims the benefit of priority from the prior Japanese Patent Application No. 2007-255688 filed on Sep. 28, 2007; the entire contents of which are incorporated herein by reference.

### BACKGROUND OF THE INVENTION

1. Field of the Invention

The present invention relates to a receiving apparatus incorporated in a wireless terminal which can be used in a wireless communicating system, more particularly, to a receiving apparatus provided with a function of eliminating an direct current offset (hereinafter, referred to as a DC offset) which is an unnecessary direct current component induced in an analog area of an RF (high frequency) area and an AGC (Automatic Gain Control) function, and a receiving method for the receiving apparatus.

2. Description of the Related Art

In a receiving apparatus of a wireless apparatus in a wireless communicating system, a signal received in the analog area of the RF area is converted to a base band. A signal frequency-converted in the RF area is converted to a digital signal, and a level of the digital signal is measured, thereby, a DC offset induced in the analog area of the RF area is detected and fed-back to the analog area, and the DC offset is canceled, or a signal level is adjusted according to the strength of the received signal.

By the way, in such a receiving apparatus for wireless communication, and in a DC offset canceller which detects the DC offset induced in the analog area of the RF area, feeds-back the DC offset to the analog area, and cancels the DC offset, when an initial pulling-in is executed in the communication start, or when a gain of a VGA (Variable Gain Amplifier) is largely changed, a large amplitude or a pulse-shaped amplitude may be induced in an output signal. Because of such a large amplitude, there occurs such a problem that an error is caused in a power averaging calculation executed by the AGC, so that a correct AGC operation is not executed.

As a conventional automatic gain control technique in a wireless communicating system, such a technique is disclosed that, when a signal exceeding a certain receiving sensitivity is received, after a gain controlling circuit roughly controls a gain of an amplifier, the DC offset is cancelled, the gain of the amplifier is highly accurately set, and an automatic gain controlling process is completed, thereby, a base band processing unit is not burdened, and the automatic gain controlling process is highly accurately executed in a short time (referred to Japanese Patent Application Laid-Open Publication No. 2004-64505).

In a variable gain amplifying circuit provided with an offset eliminating function which amplifies a deference signal between an input signal and a feed back signal, a variable gain amplifier is disclosed, in which only a predetermined low frequency component of frequency components of a output signal of a amplifying circuit is fed-back to an inverting terminal of the amplifying circuit, thereby, even if the gain of the amplifying circuit is changed, it is possible to suppress a variation of a lower limit frequency because of such a gain change, and to execute a favorable offset canceling (referred to Japanese Patent Application Laid-Open Publication No. 2003-174340).

A DC offset adjusting circuit is disclosed, in which, through a predetermined time immediately after the power is turned on, an attenuation rate or an amplification rate of a gain adjusting circuit, such as a PIN attenuator and an AGC amplifier, provided in a former stage of an orthogonal detector is controlled, a non-input condition to the orthogonal detector is induced, an input to a demodulator is averaged while the non-input condition is continued, and a DC offset adjustment quantity is determined for the demodulator, thereby, it is possible to realize a time reduction to determine a highly-stable receiving sensitivity, an adjacent channel selectivity characteristic, and an offset adjustment quantity (referred to Japanese Patent Application Laid-Open Publication No. 2000-216836).

However, in any document of Japanese Patent Application Laid-Open Publication No. 2004-64505 and Japanese Patent Application Laid-Open Publication No. 2003-174340, the control is not such that the AGC is not subject to a malfunction caused by a distortion of the received signal, which is induced when the DC offset canceller is pulled in.

In Japanese Patent Application Laid-Open Publication No. 2000-216836, because the input signal in the former stage of an orthogonal detector 24 is caused to be in the non-input condition, and the DC offset is calculated in a demodulator 26, it is necessary to minimize the gain of the AGC to have the non-input condition. In such a case, the communication is not available. That is, there is such a restriction that the DC offset needs to be calculated before the communication is started.

### SUMMARY OF THE INVENTION

According to an aspect of the present invention, a receiving apparatus for wireless communication is provided, which includes:

an orthogonal demodulator configured to orthogonally demodulate a received signal;

a demodulator configured to demodulate a symbol from the received signal orthogonally demodulated by the orthogonal demodulator;

an amplifier configured to be provided in a former stage of the demodulator to amplify the received signal;

an offset value calculating unit configured to time-average the received signal from the orthogonal demodulator to the demodulator to detect a DC offset value, and feed back the DC offset value to a signal channel from the orthogonal demodulator to the demodulator to cancel the DC offset value;

an automatic gain controlling unit configured to calculate and time-average a power of the received signal from the orthogonal demodulator to the demodulator to generate an AGC signal, and control a gain of the amplifier; and

a controlling unit configured to control to interlock (synchronize) a DC offset value detecting operation of the offset value calculating unit and an AGC signal generating operation of the automatic gain controlling unit.

According to another aspect of the present invention, a receiving method of the receiving apparatus for wireless communication is provided, the receiving apparatus includes:

the orthogonal demodulator configured to orthogonally demodulate the received signal;

the demodulator configured to demodulate the symbol from the received signal orthogonally demodulated by the orthogonal demodulator; and

the amplifier configured to be provided in the former stage of the demodulator to amplify the received signal,

and the receiving method includes:

time-averaging the received signal from the orthogonal demodulator to the demodulator to detect the DC offset value;

feeding back the DC offset value to the signal channel from the orthogonal demodulator to the demodulator to cancel the DC offset value;

calculating and time-averages the power of the received signal from the orthogonal demodulator to the demodulator to generate the AGC signal;

controlling the gain of the amplifier; and

interlocking (synchronizing) the DC offset value detecting operation and the AGC signal generating operation.

### BRIEF DESCRIPTION OF THE DRAWINGS

FIG. 1 is a block diagram illustrating a receiving apparatus for wireless communication according to an embodiment of the present invention;

FIG. 2 is a block diagram illustrating an exemplary configuration of an offset value calculating unit in FIG. 1;

FIG. 3 is a block diagram illustrating an exemplary configuration of an AGC unit in FIG. 1;

FIG. 4 is a block diagram illustrating an exemplary configuration of a controlling unit in FIG. 1;

FIG. 5 is a flowchart describing an exemplary operation of the controlling unit in FIG. 1;

FIG. 6 is a block diagram illustrating a power averaging stopping method in the AGC unit;

FIG. 7 is a block diagram illustrating a specific exemplary configuration of a register unit in FIG. 6;

FIG. 8 is a timing chart describing an operation of FIG. 7; and

FIG. 9 is a timing chart illustrating a time relation between a DC offset value and a controlling signal when commonly using an AGC averaging start/stop controlling signal, and a DC offset value normal averaging/high rate averaging switching signal.

### DETAILED DESCRIPTION OF THE PREFERRED EMBODIMENTS

An embodiment of the present invention will be described referring to the drawings. In the embodiment of the present invention, a receiving apparatus of a wireless-communicating wireless apparatus (for example, a portable phone) will be described.

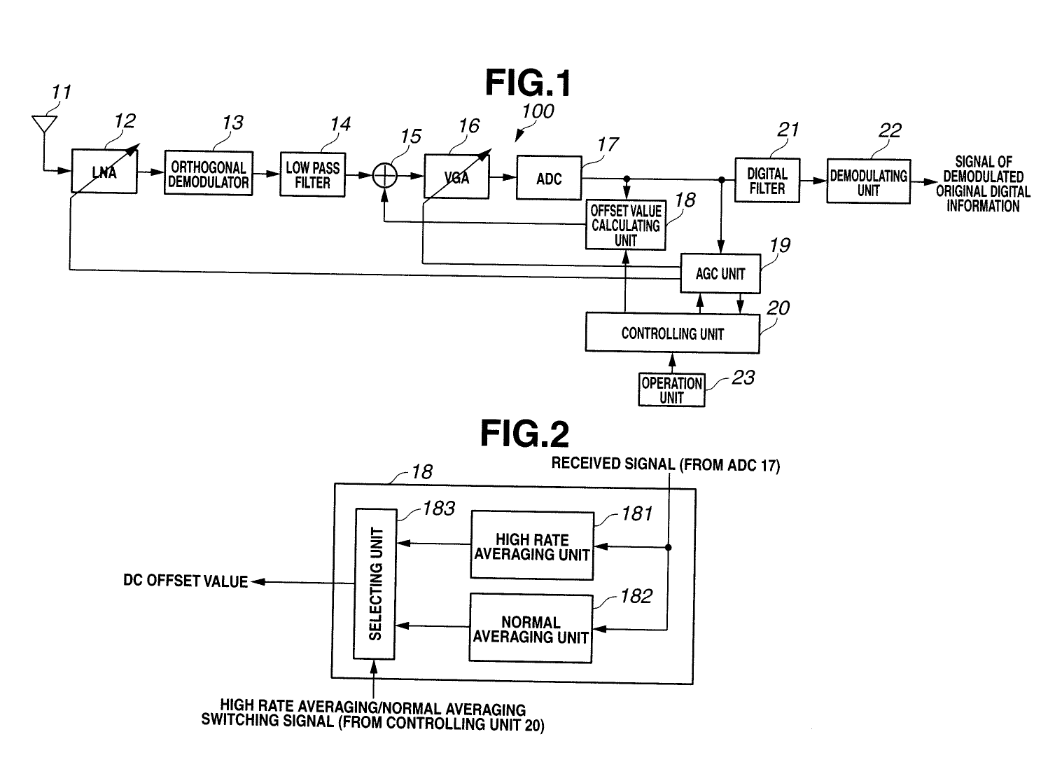

FIG. 1 is a block diagram illustrating the receiving apparatus for wireless communication according to the embodiment of the present invention.

In a receiving apparatus 100 for the wireless communication of FIG. 1, a high frequency signal including a digital modulation signal received by an antenna 11 is amplified by a low noise amplifier (hereinafter, abbreviated as LNA) 12 in which a gain can be switched, is converted to a base band signal (the I signal which is an in-phase component of a base wave and the Q signal which is an orthogonal component of the base signal) by an orthogonal demodulator 13, is filtered by a low pass filter 14 for eliminating a noise and an interference wave, is added by a DC offset value to eliminate an offset in an adder 15, and is amplified by a variable gain amplifier (hereinafter, abbreviated as VGA) 16.

The LNA 12 is controlled by an automatic gain controlling unit (hereinafter, abbreviated as AGC unit) 19 to be gain-adjusted by a few steps (for example, two steps), and the VGA 16 is controlled by the AGC unit 19 to be continuously gain-adjusted.

The signal amplified by the VGA 16 is converted from an analog signal to a digital signal by an A/D converting unit (hereinafter, abbreviated as ADC) 17. For the signal converted to the digital signal, a DC offset value is calculated by an offset value calculating unit 18, and is fed back to the adder 15 provided in an analog area in a former stage of the ADC 17, and the offset is eliminated by subtracting the DC offset value. The gain is calculated by the AGC unit 19 for the signal converted to the digital signal, and the gains of the VGA 16 and the LNA 12 are controlled.

The offset value calculating unit 18 averages the digitally-converted signal from the ADC 17 for a certain time to generate the DC offset value, and negatively feeds back the generated DC offset value to the adder 15. The AGC unit 19 calculates the power based on the digitally-converted signal from the ADC 17, and averages the power for a certain time to generate a gain controlling signal (hereinafter, abbreviated as AGC signal) corresponding to the gain adjustment of each of the VGA 16 and the LNA 12.

The controlling unit 20 executes a controlling operation based on a signal indicating a communication start from an operation unit 23, and the AGC signal from the AGC unit 19, and includes a function which interlocks (synchronizes) and controls an DC offset value detecting operation of the offset value calculating unit 18, and an AGC signal generating operation of the AGC unit 19.

The digital signal converted by the ADC 17 is filtered by a digital filter 21, and is finally demodulated by a demodulating unit 22 to an original digital information signal, whose symbols are 0 and 1, included in the digitized base band signal.

FIG. 2 is a block diagram illustrating an exemplary configuration of the offset value calculating unit 18.

In FIG. 2, the offset value calculating unit 18 is provided with a high rate averaging unit 181 configured to average the received signal by a low pass filter with a first frequency characteristic to detect a DC offset value, a normal averaging unit 182 configured to average the received signal by a low pass filter with a second frequency characteristic, whose band width is narrower than that of the first frequency characteristic, to detect the DC offset value, And a selecting unit 183 configured to select the DC offset value detected by the high rate averaging unit 181 and the DC offset value detected by the normal averaging unit 182 according to a switching signal from the controlling unit 20 for a high rate averaging and a normal averaging.

The offset value calculating unit 18 time-averages the received signal from the ADC 17 to obtain the DC offset value. The received signal is averaged by the high rate averaging unit 181 obtaining an average in a high rate, or the normal averaging unit 182 obtaining an average in a normal rate. Since a time (time constant) to time-average the received signal in the high rate averaging is short, while the received signal can be averaged quickly, an average value may be fluctuated. While it takes longer to obtain the average value since a time (time constant) to time-average the received signal in the normal averaging is longer, the average value becomes stable. The controlling unit 20 switches between the two modes obtaining the average according to an averaging time. Specifically, the average value outputted from the high rate averaging unit 181 and the average value outputted from the normal averaging unit 182 are inputted to the selecting unit 183, and any one of the two average values is selectively switched by a high rate averaging/normal averaging switching signal, and is outputted.

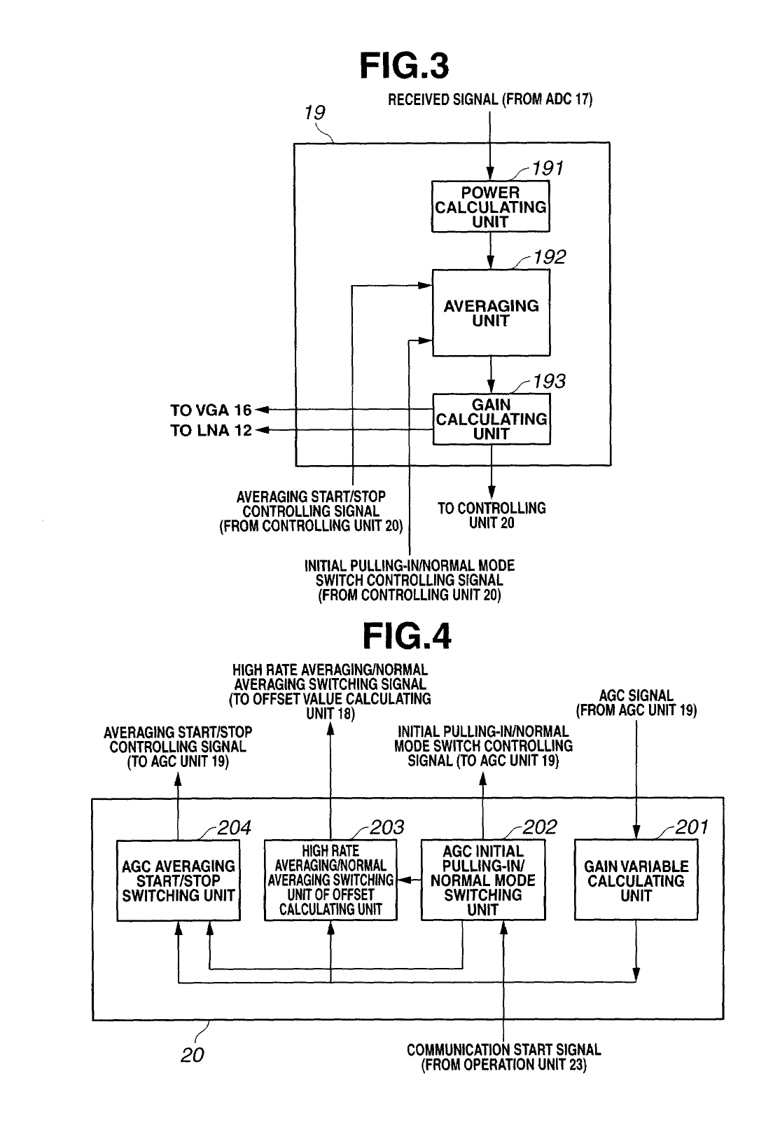

FIG. 3 is a block diagram illustrating an exemplary configuration of the AGC unit 19.

In FIG. 3, the AGC unit 19 is provided with a power calculating unit 191 configured to calculate the power of the received signal from the ADC 17, an averaging unit 192 configured to time-average the calculated power, and a gain calculating unit 193 configured to generate the AGC signal corresponding to the gain adjustment for each of the VGA 16 and the LNA 12 based on the time-averaged power. The AGC signal for the VGA 16, which needs the continuous gain adjustment, is also delivered to the controlling unit 20.

The averaging unit 192 is provided with, not-illustrated, a high rate averaging unit configured to average a power value from the power calculating unit 191 by the low pass filter with a third frequency characteristic in the initial pulling-in for starting the communication to execute a high rate power averaging in which a time (time constant) is short in the initial pulling-in, and a normal averaging unit configured to average the power value from the power calculating unit 191 by the low pass filter with a fourth frequency characteristic, whose band width is narrower than that of the third frequency characteristic in a normal mode, to execute a normal power averaging in which a time (time constant) is longer in the normal mode, and enables such two averaging units to be switched by an initial pulling-in/normal mode switch controlling signal from the controlling unit 20. The start and stop of the averaging operation of the averaging unit 192 can be controlled by an averaging start/stop controlling signal of the controlling unit 20.

FIG. 4 is a block diagram illustrating an exemplary configuration of the controlling unit 20.

In FIG. 4, the controlling unit 20 is provided with a gain variable calculating unit 201 configured to input the AGC signal from the AGC unit 19, and compare a time-changed quantity of the AGC signal with a threshold value to detect an amplitude of a gain-changed quantity, an AGC initial pulling-in/normal mode switching unit 202 configured to input a signal indicating the communication start to deliver an AGC initial pulling-in/normal mode switching signal according to the existence of the signal indicating the communication start to the AGC unit 19, a high rate averaging/normal averaging switching unit 203 configured to input an output from the gain variable calculating unit 201 and an output from the AGC initial pulling-in/normal mode switching unit 202, and generate the high rate averaging/normal averaging switching signal to deliver the generated high rate averaging/normal averaging switching signal to the offset value calculating unit 18, and an AGC averaging start/stop switching unit 204 configured to input the output from the gain variable calculating unit 201 and the output from the AGC initial pulling-in/normal mode switching unit 202, and generate the averaging start/stop controlling signal to deliver the generated averaging start/stop controlling signal to the AGC unit 19.

The controlling unit 20 controls the AGC unit 19 and the offset value calculating unit 18 for the initial pulling-in to execute the AGC initial pulling-in when the communication is started (herein, the receiving is started).

In the normal mode, the AGC unit 19 informs the controlling unit 20 of the updated gain every time the gain is updated (this means that the gain is changed in each fixed period according to the amplitude of the received signal), the controlling unit 20 determines from the informed gain whether or not the DC offset value becomes larger, and when the DC offset value becomes larger, the controlling unit 20 controls the offset value calculating unit 18 to select the high rate averaging, and stops the averaging operation of the AGC unit 19. While the gain is updated corresponding to the gain change in each fixed period, if the gain is not changed, as a result, the updated gain becomes the same as the former gain. When the amplitude of the received signal is changed, for example, when the amplitude of the received electric wave is rapidly changed, the gain is updated (changed) in each fixed period.

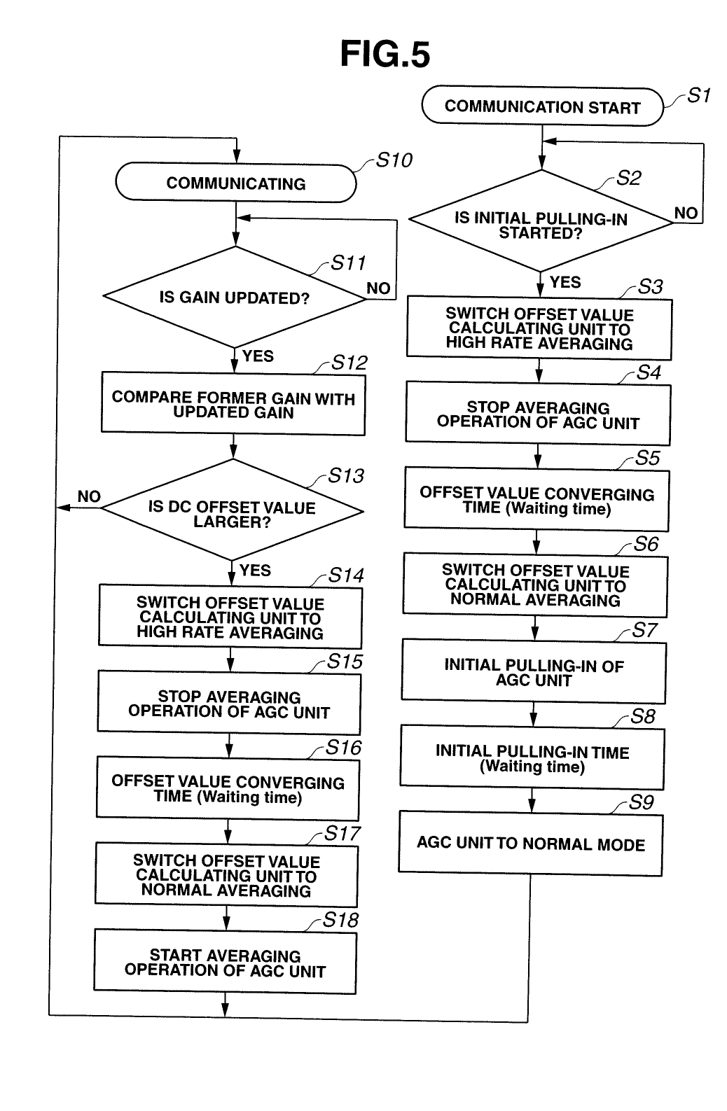

FIG. 5 is a flowchart describing an exemplary operation of the controlling unit 20.

In FIG. 5, the communication is started, for example, when a receiving button of an operation unit of the receiving apparatus is operated (step S1). When the communication is started, the initial pulling-in is started (step S2). When the initial pulling-in is started, the offset value calculating unit 18 is switched to the high rate averaging (step S3), and the averaging operation of the averaging unit 192 of the AGC unit 19 is stopped (step S4). When a time period lapses in which the high rate averaging of the offset value calculating unit 18 is converged (step S5), the offset value calculating unit 18 is set to the normal averaging (step S6), and the initial pulling-in of the AGC unit 19 is started (step S7). When a time period for the initial pulling-in in the AGC unit 19 lapses (step S8), the averaging unit 192 of the AGC unit 19 is set to the normal mode (step S9), and the controlling unit 20 becomes to be in the communication condition (step S10).

When the gain of the AGC unit 19 is updated in the normal communication (step S11), the previously-set gain is compared with the updated gain (step S12), it is determined from a result of the comparison whether or not the DC offset value becomes larger (step S113), and when the DC offset value becomes larger, the offset value calculating unit 18 is set to the high rate averaging (step S14), and the averaging operation of the averaging unit 192 of the AGC unit 19 is stopped (step S15). When a time period lapses in which the high rate averaging of the offset value calculating unit 18 is converged (step S16), the offset value calculating unit 18 is set to the normal averaging (step S17), and the averaging operation of the averaging unit 192 of the AGC unit 19 is started (step S18).

Meanwhile, to stop the averaging operation of the AGC unit 19 at the above steps S4 and S15 is to stop the substantial power averaging operation in which the time-changed received signal is reflected, and while the power averaging operation is stopped, the constant power value is continuously outputted as a power value output.

Conventionally, when a DC offset value is large, the power averaging of the AGC unit 19 can not be correctly calculated, and the AGC unit 19 can not be correctly controlled instantaneously, so that the receiving quality may be degraded. However, in the present embodiment, when a gain is changed or an initial pulling-in is executed, and when a DC offset becomes larger, the power average of the received signal is not directly obtained, but the high rate averaging is selected by the offset value calculating unit 18, and while the high rate averaging is being selected, the power averaging of the AGC unit 19 is stopped, and when the DC offset has been eliminated, the power averaging of the AGC unit 19 is started, thereby, it is possible to eliminate the influence of the DC offset, and to eliminate the DC offset while maintaining the favorable receiving quality. In other words, such a phenomenon is induced that, when the gain is largely changed, the DC offset also becomes larger, so that, since the AGC unit 19 and the offset value calculating unit 18 are interlocked (synchronized) to be controlled, it is possible to eliminate the malfunction of the AGC and the degradation of the receiving quality because of the DC offset.

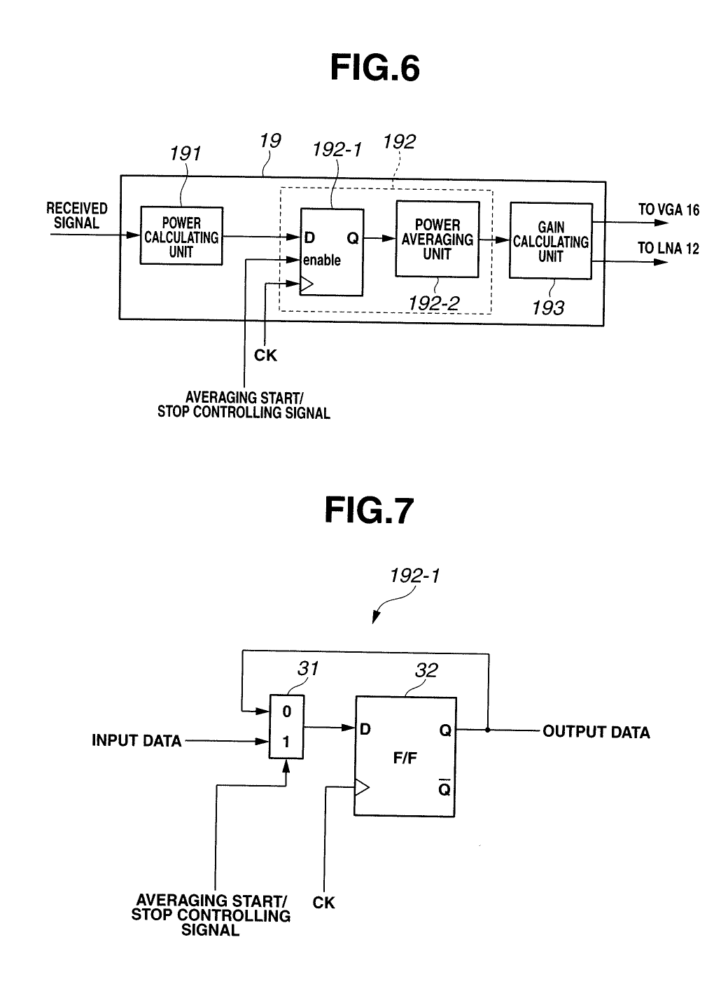

FIG. 6 is a block diagram of the AGC unit 19 illustrating a power averaging stopping method. In FIG. 6, the same code is attached to the same component as that of FIG. 3.

As described in FIG. 3, in FIG. 6, the AGC unit 19 is provided with the power calculating unit 191, the averaging unit 192, and the gain calculating unit 193.

The averaging unit 192 is provided with a register unit 192-1 configured to latch input data delivered from the power calculating unit 191 in a cycle of a clock CK to output the latched input data when the averaging start/stop controlling signal is a high level signal according to a high level/low level of the averaging start/stop controlling signal, and to stop latching the input data to continue to output the data latched before the stopping when the averaging start/stop controlling signal is the low level signal, and a power averaging unit 192-2 configured to average the power value outputted from the register unit 192-1 in each fixed period. Meanwhile, while the averaging start/stop controlling signal is the low level signal, the averaging unit 192 stops inputting the power-calculated data to continue to output the data latched before the stopping, so that the above condition is substantially such a condition that the calculation operation for the power averaging is stopped.

As in FIG. 3, the gain calculating unit 193 converts the time-averaged power value from the averaging unit 192 to first and second AGC signals which are gain control values corresponding to the continuous gain adjustment and the stepwise gain adjustment for the VGA 16 and the LNA 12 respectively, and delivers the first and second AGC signals to the VGA 16 and the LNA 12 respectively. Meanwhile, the second AGC signal delivered to the VGA 16 is also delivered to the controlling unit 20.

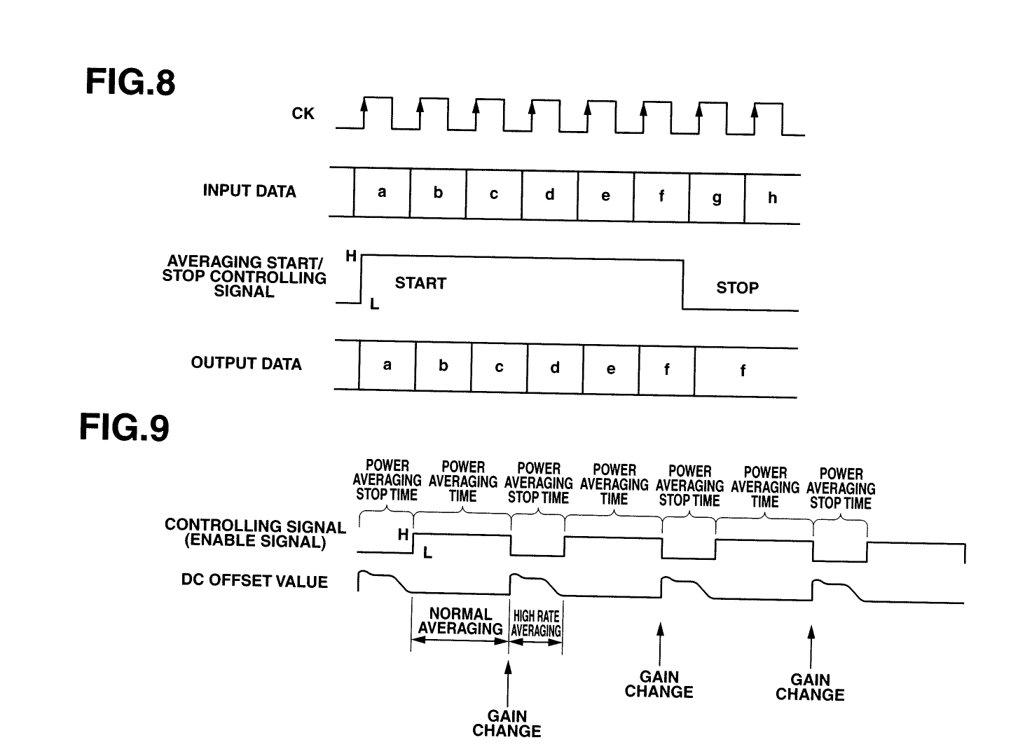

In the above configuration, the signal power-calculated by the power calculating unit 191 is temporarily latched by the register unit 192-1, and is later power average-calculated by the power averaging unit 192-2. When the averaging start/stop controlling signal, which is the high level/low level signal, is the high level signal, the averaging start/stop controlling signal becomes an enable signal which causes the register unit 192-1 to latch a signal, and when the averaging start/stop controlling signal is the low level signal, the averaging start/stop controlling signal becomes a disable signal which causes the register unit 192-1 not to latch a signal. Thereby, it is possible to control to start/stop the power averaging. The detailed operation of the register unit 192-1 will be described in FIG. 7 and FIG. 8.

Meanwhile, as in the description of the averaging unit 192 of FIG. 3, although the power averaging unit 192-2 controls to switch the initial pulling-in/normal mode, and can switch the non-illustrated high rate averaging unit and normal averaging unit, the description will be omitted since the switching is not the main point of the present embodiment.

FIG. 7 illustrates a specific exemplary configuration of the register unit 192-1. The register unit 192-1 is provided with a selecting circuit 31 and a D-type flip-flop (hereinafter, abbreviated as F/F) 32.

The selecting circuit 31 selectively switches a terminal ‘1’ of input data delivered from the power calculating unit 191, and a terminal ‘0’ inputting output data from the F/F 32 according to the high level and the low level of the averaging start/stop controlling signal. When the averaging start/stop controlling signal is the high level signal, the terminal ‘1’ of the input data is selected, and the data delivered from the power calculating unit 191 is outputted from the selecting circuit 31. When the averaging start/stop controlling signal is the low level signal, the terminal ‘0’ is selected, and the output data from the F/F 32 is outputted from the selecting circuit 31. The data selected by the selecting circuit 31 is inputted to a terminal D of the F/F 32.

The F/F 32 is provided with the terminal D to which the data is inputted from the selecting circuit 31, a clock terminal to which the clock CK is inputted, an output terminal Q, and an inverted output terminal /Q, and, for example, latches the data inputted to the terminal D at a rising timing of the clock in each clock cycle to output the latched data from the output terminal Q. The output data of the F/F 32 is inputted to the terminal ‘0’ of the selecting circuit 31, and when the terminal ‘0’ is selected, the output data of the F/F 32 is delivered to the terminal D of the F/F 32 in each clock cycle, so that the same data (the latched data before the selecting circuit 31 is switched) is continuously outputted from the F/F 32.

FIG. 8 is a timing chart describing a circuit operation of FIG. 7.

In the selecting circuit 31, according to the high level and the low level of the averaging start/stop controlling signal from the controlling unit 20, the signal to be outputted to the terminal D of the F/F 32 is switched, so that, when the averaging start controlling signal (high level) is delivered, the power-calculated data from the power calculating unit 191 (this data is data in which the time-changed received signal is reflected, and in FIG. 8, a power-calculated data sequence is designated to be a, b, c, - - - ) is delivered as the input data to the D terminal of the F/F 32, in the F/F 32, the input data is latched (inputted) at a rising timing of the clock CK, and the data latched (inputted) in the clock cycle of the F/F 32 is sequentially outputted from the output terminal Q of the F/F 32. That is, when the averaging start operation is executed in the AGC unit 19, the output data of the register unit 192-1 is updated to be outputted in each clock cycle.

After that, when the averaging stop controlling signal (low level) is delivered, the output data of the selecting circuit 31 is delivered as the input data to the terminal D of the F/F 32, and in the F/F 32, the output data before the averaging operation of the F/F 32 is stopped is sequentially fed back to the input side of the F/F 32 through the selecting circuit 31 in a cycle of the clock CLK to be continuously inputted again, as a result, the F/F 32 continues to output the same data (a constant value to which the changed received signal is not reflected) as the data latched before the averaging operation is stopped. That is, when the averaging stop operation is executed in the AGC unit 19, the output data of the register unit 192-1 is not updated, and the constant data is outputted.

Meanwhile, in the above configuration of the embodiment of the present invention, it is also possible to commonly use the averaging start/stop controlling signal of the AGC and the high rate averaging/normal averaging switching signal of the DC offset value. In a case where such signals are used as a common controlling signal, when the controlling signal is the high level signal, the averaging start of the AGC unit 19 and the normal averaging of the offset value calculating unit 18 are to be selected, and when the controlling signal is the low level signal, the averaging stop of the AGC unit 19 and the high rate averaging of the offset value calculating unit 18 are to be selected.

FIG. 9 illustrates a relation between the DC offset value and the controlling signal when the controlling signal is commonly used as described above. When the controlling signal is the low level signal, that is, while the offset value calculating unit 18 selects the high rate averaging, and the power averaging unit 192-2 of the AGC unit 19 is stopped, the DC offset value is converged in a high rate, after the converging, the controlling signal is set to be the high level signal, the averaging operation of the power averaging unit 192-2 of the AGC unit 19 is started, and the normal averaging is selected for the DC offset. As controlled as the above, it becomes possible to control only by the controlling signal of the high level/low level, and it is possible to simplify the configuration and the operation of the controlling unit 20.

According to the present embodiment, it is possible to calculate the DC offset and arbitrarily cancel the DC offset without stopping the input signal during the communication, and with executing the gain control for the AGC. The time constant of the averaging for obtaining the DC offset value is switched by the gain control of the AGC so that the AGC is not subject to a malfunction caused by the distortion of the received signal, which is induced when the DC offset canceller is pulled in, thereby, it is possible to control to correctly interlock (synchronize) the DC offset cancel and the AGC.

Having described the embodiments of the invention referring to the accompanying drawings, it should be understood that the present invention is not limited to those precise embodiments and various changes and modifications thereof could be made by one skilled in the art without departing from the spirit or scope of the invention as defined in the appended claims.

What is claimed is:

1. A receiving apparatus for wireless communication, comprising:
an orthogonal demodulator configured to orthogonally demodulate a received signal;
a demodulator configured to demodulate a symbol from the received signal orthogonally demodulated by the orthogonal demodulator;
an amplifier configured to be provided in a former stage of the demodulator to amplify the received signal;
an offset value calculating unit configured to time-average the received signal from the orthogonal demodulator to the demodulator to detect a DC offset value, and feed back the DC offset value to a signal channel from the orthogonal demodulator to the demodulator to cancel the DC offset value;
an automatic gain controlling unit configured to calculate and time-average a power of the received signal from the orthogonal demodulator to the demodulator to generate an AGC signal, and control a gain of the amplifier; and
a controlling unit configured to control to interlock (synchronize) a DC offset value detecting operation of the offset value calculating unit and an AGC signal generating operation of the automatic gain controlling unit.

2. The receiving apparatus for wireless communication according to claim 1,
wherein the offset value calculating unit including:
a high rate averaging unit configured to average the received signal by a low pass filter with a first frequency characteristic to detect the DC offset value;
a normal averaging unit configured to average the received signal by the low pass filter with a second frequency characteristic, whose band width is narrower than that of the first frequency characteristic, to detect the DC offset value; and
a selecting unit configured to select the DC offset value detected by the high rate averaging unit and the DC offset value detected by the normal averaging unit according to a switching signal from the controlling unit for a high rate averaging and a normal averaging.

3. The receiving apparatus for wireless communication according to claim 1,
wherein the automatic gain controlling unit including:
a power calculating unit configured to calculate the power of the received signal;
an averaging unit configured to time-average the calculated power; and
a gain calculating unit configured to generate the AGC signal corresponding to gain adjustment for the amplifier based on the time-averaged power value,
wherein the averaging unit includes:
a high rate averaging unit configured to average the power value from the power calculating unit by a low pass filter with a third frequency characteristic in a initial pulling-in for starting a communication; and
a normal averaging unit configured to average the power value from the power calculating unit in a normal mode by the low pass filter with a fourth frequency characteristic, whose band width is narrower than the band width of the third frequency characteristic,
an average value from the high rate averaging unit and an average value from the normal averaging unit can be selectively switched by a switch controlling signal for the initial pulling-in and the normal mode from the controlling unit, and a power averaging operation by the averaging unit can be controlled to be started and stopped by a controlling signal of the controlling unit for starting and stopping averaging.

4. The receiving apparatus for wireless communication according to claim 1,
wherein the automatic gain controlling unit including:
a register unit configured to start and stop a power averaging operation by an averaging unit of the automatic gain controlling unit,
a controlling signal from the controlling unit for starting and stopping the power averaging operation of the automatic gain controlling unit is designated to be a high level/low level signal, when the controlling signal is the high level signal, the power averaging operation can be executed by causing the register unit to latch and output a power value of the received signal, and when the controlling signal is a low level signal, the power averaging operation can be stopped by causing the register unit not to latch the power value of the received signal but to output a constant value.

5. The receiving apparatus for wireless communication according to claim 2,
wherein the automatic gain controlling unit including:
a register unit configured to start and stop a power averaging operation by an averaging unit of the automatic gain controlling unit,
a controlling signal from the controlling unit for starting and stopping the power averaging operation of the automatic gain controlling unit is designated to be a high level/low level signal, when the controlling signal is the high level signal, the power averaging operation can be executed by causing the register unit to latch and output a power value of the received signal, and when the controlling signal is the low level signal, the power averaging operation can be stopped by causing the register unit not to latch the power value of the received signal but to output a constant value.

6. The receiving apparatus for wireless communication according to claim 3,
wherein the automatic gain controlling unit including:
a register unit configured to start and stop the power averaging operation by an averaging unit of the automatic gain controlling unit,
a controlling signal from the controlling unit for starting and stopping the power averaging operation of the automatic gain controlling unit is designated to be a high level/low level signal, when the controlling signal is the high level signal, the power averaging operation can be executed by causing the register unit to latch and output a power value of the received signal, and when the controlling signal is the low level signal, the power averaging operation can be stopped by causing the register unit not to latch the power value of the received signal but to output a constant value.

7. The receiving apparatus for wireless communication according to claim 1,
wherein the controlling unit executes a controlling operation based on a signal indicating a communication start from an operation unit and the AGC signal from the automatic gain controlling unit,
when the DC offset value becomes larger since the AGC signal is largely changed, the offset value calculating unit detects the DC offset value in a high rate averaging operation, the automatic gain controlling unit stops a power averaging operation for a high rate averaging time, and when a DC offset is eliminated by the high rate averaging, the automatic gain controlling unit starts the power averaging operation, and also the offset value calculating unit controls to switch the high rate averaging operation to a normal averaging operation.

8. The receiving apparatus for wireless communication according to claim 2,
wherein the controlling unit executes a controlling operation based on a signal indicating a communication start from an operation unit and the AGC signal from the automatic gain controlling unit,
when the DC offset value becomes larger since the AGC signal is largely changed, the offset value calculating unit detects the DC offset value in a high rate averaging operation, the automatic gain controlling unit stops a power averaging operation for the high rate averaging time, and when a DC offset is eliminated by the high rate averaging, the automatic gain controlling unit starts the power averaging operation, and also the offset value calculating unit controls to switch the high rate averaging operation to the normal averaging operation.

9. The receiving apparatus for wireless communication according to claim 3,
wherein the controlling unit executes a controlling operation based on a signal indicating a communication start from an operation unit and the AGC signal from the automatic gain controlling unit,
when the DC offset value becomes larger since the AGC signal is largely changed, the offset value calculating unit detects the DC offset value in a high rate averaging operation, the automatic gain controlling unit stops a power averaging operation for a high rate averaging time, and when a DC offset is eliminated by the high rate averaging, the automatic gain controlling unit starts the power averaging operation, and also the offset value calculating unit controls to switch the high rate averaging operation to a normal averaging operation.

10. The receiving apparatus for wireless communication according to claim 4,
wherein the controlling unit executes a controlling operation based on a signal indicating a communication start from an operation unit and the AGC signal from the automatic gain controlling unit,
when the DC offset value becomes larger since the AGC signal is largely changed, the offset value calculating unit detects the DC offset value in a high rate averaging operation, the automatic gain controlling unit stops the power averaging operation for a high rate averaging time, and when a DC offset is eliminated by the high rate averaging, the automatic gain controlling unit starts the power averaging operation, and also the offset value calculating unit controls to switch the high rate averaging operation to a normal averaging operation.

11. The receiving apparatus for wireless communication according to claim 5,
wherein the controlling unit executes a controlling operation based on a signal indicating a communication start from an operation unit and the AGC signal from the automatic gain controlling unit,
when the DC offset value becomes larger since the AGC signal is largely changed, the offset value calculating unit detects the DC offset value in a high rate averaging operation, the automatic gain controlling unit stops the power averaging operation for a high rate averaging time, and when a DC offset is eliminated by a high rate averaging, the automatic gain controlling unit starts the power averaging operation, and also the offset value calculating unit controls to switch the high rate averaging operation to a normal averaging operation.

12. The receiving apparatus for wireless communication according to claim 6,
wherein the controlling unit executes a controlling operation based on a signal indicating the communication start from an operation unit and the AGC signal from the automatic gain controlling unit,
when the DC offset value becomes larger since the AGC signal is largely changed, the offset value calculating unit detects the DC offset value in a high rate averaging operation, the automatic gain controlling unit stops the power averaging operation for a high rate averaging time, and when a DC offset is eliminated by the high rate averaging, the automatic gain controlling unit starts the power averaging operation, and also the offset value calculating unit controls to switch the high rate averaging operation to a normal averaging operation.

13. The receiving apparatus for wireless communication according to claim 1,
wherein the controlling unit including:
a gain variable calculating unit configured to input the AGC signal from the automatic gain controlling unit, and compare a time-changed quantity of the AGC signal with a threshold value to detect an amplitude of a gain-changed quantity;
an AGC initial pulling-in/normal mode switching unit configured to input a signal indicating a communication start to deliver an AGC initial pulling-in/normal mode switching signal according to an existence of the signal indicating the communication start to the automatic gain controlling unit;
a high rate averaging/normal averaging switching unit configured to input an output from the gain variable calculating unit and an output from the AGC initial pulling-in/normal mode switching unit, and generate a high rate averaging/normal averaging switching signal to deliver the generated high rate averaging/normal averaging switching signal to the offset value calculating unit; and
an AGC averaging start/stop switching unit configured to input the output from the gain variable calculating unit and the output from the AGC initial pulling-in/normal mode switching unit, and generate an averaging start/stop controlling signal to deliver the generated averaging start/stop controlling signal to the automatic gain controlling unit.

14. The receiving apparatus for wireless communication according to claim 3,
wherein the gain calculating unit calculates, based on a power averaged by the averaging unit, a first AGC signal corresponding to stepwise gain adjustment of a low noise amplifier in a former stage of the orthogonal demodulator, and a second AGC signal corresponding to continuous gain adjustment of a variable gain amplifier in a former stage of the demodulator.

15. The receiving apparatus for wireless communication according to claim 14,
wherein the second AGC signal is also delivered to the controlling unit.

16. The receiving apparatus for wireless communication according to claim 4,
wherein the register unit including:
a selecting circuit configured to include two input terminal, to which a first input data which is a power value of the received signal and a second input data are inputted, and one output terminal, select and output a first input data when an averaging start/stop controlling signal of the controlling unit is the high level signal, and select and output the second input data when the averaging start/stop controlling signal of the controlling unit is the low level signal; and
a D-type flip flop configured to latch data, which is obtained by inputting output data from the selecting circuit to a D terminal at a rising timing of a clock, in each clock cycle and output the latched data from a Q terminal, and deliver an output of the Q terminal as the second input data to one input terminal of the selecting circuit.

17. The receiving apparatus for wireless communication according to claim 5,
wherein the register unit including:
a selecting circuit configured to include two input terminal, to which a first input data which is a power value of the received signal and a second input data are inputted, and one output terminal, select and output the first input data when an averaging start/stop controlling signal of the controlling unit is the high level signal, and select and output the second input data when the averaging start/stop controlling signal of the controlling unit is the low level signal; and
a D-type flip flop configured to latch data, which is obtained by inputting data outputted from a selecting circuit to a D terminal at a rising timing of a clock, in each clock cycle and output inputted data from a Q terminal, and deliver an output of the Q terminal as the second input data to one input terminal of the selecting circuit.

18. The receiving apparatus for wireless communication according to claim 6,
wherein the register unit including:
a selecting circuit configured to include two input terminal, to which a first input data which is the power value of the received signal and a second input data are inputted, and one output terminal, select and output the first input data when an averaging start/stop controlling signal of the controlling unit is a high level signal, and select and output the second input data when the averaging start/stop controlling signal of the controlling unit is a low level signal; and
a D-type flip flop configured to latch data, which is obtained by inputting data outputted from a selecting circuit to a D terminal at a rising timing of a clock, in each clock cycle and output inputted data from a Q terminal, and deliver an output of the Q terminal as the second input data to one input terminal of the selecting circuit.

19. The receiving apparatus for wireless communication according to claim 13,
wherein the averaging start/stop controlling signal for the AGC and the high rate averaging/normal averaging switching signal for the DC offset value are used as a common controlling signal, when the common controlling signal is a high level signal, an averaging start of the automatic gain controlling unit and a normal averaging of the offset value calculating unit are selected, and when the common controlling signal is a low level signal, an averaging stop of the automatic gain controlling unit and the high rate averaging of the offset value calculating unit are selected.

20. A receiving method for a receiving apparatus for wireless communication,
the receiving apparatus including:
an orthogonal demodulator configured to orthogonally demodulate a received signal;
a demodulator configured to demodulate a symbol from the received signal orthogonally demodulated by the orthogonal demodulator; and
an amplifier configured to be provided in a former stage of the demodulator to amplify the received signal,
comprising:
time-averaging the received signal from the orthogonal demodulator to the demodulator to detect a DC offset value;
feeding back the DC offset value to a signal channel from the orthogonal demodulator to the demodulator to cancel the DC offset value;
calculating and time-averaging a power of the received signal from the orthogonal demodulator to the demodulator to generate an AGC signal;
controlling a gain of the amplifier; and
interlocking (synchronizing) the DC offset value detecting operation and the AGC signal generating operation.
